(19) United States
(12) Patent Application Publication
(10) Pub. No.: US 2020/0094704 A1
(43) Pub. Date: Mar. 26, 2020

(54) ACCOMMODATION FACILITY MANAGEMENT SYSTEM AND ACCOMMODATION FACILITY MANAGEMENT METHOD

(71) Applicant: HONDA MOTOR CO., LTD., Tokyo (JP)

(72) Inventors: Hirotaka Uchitomi, Tokyo (JP); Kei Nakajima, Tokyo (JP); Kichinosuke Fukuhara, Wako-shi (JP)

(21) Appl. No.: 16/544,164

(22) Filed: Aug. 19, 2019

(30) Foreign Application Priority Data
Sep. 20, 2018 (JP) 2018-175632

(51) Int. Cl. B60L 53/64; B60L 53/66; B60L 53/62; G06Q 50/06

(52) U.S. Cl. CPC B60L 53/64; G06Q 50/06; B60L 53/62; B60L 53/665

(57) ABSTRACT

An accommodation facility management system includes a power use mode recognizing section that recognizes a power use mode in a private accommodation facility by a user of the private accommodation facility, and an electricity use plan selecting section that selects an electricity use plan of the private accommodation facility for a period of use of the private accommodation facility by the user, based on the power use mode recognized by the power use mode recognizing section.

### INCORPORATION BY REFERENCE

The present application claims priority under 35 U.S.C. § 119 to Japanese Patent Application No. 2018-175632 filed on Sep. 20, 2018. The content of the application is incorporated herein by reference in its entirety.

### BACKGROUND OF THE INVENTION

### Field of the Invention

The present invention relates to an accommodation facility management system.

### Description of the Related Art

Heretofore, an information suggestion system has been known which suggests information on peripheral facilities of private accommodation facilities to applicants for use of the private accommodation facilities (e.g., see a publication of Japanese Patent Laid-Open No. 2017-111779). In the above information suggestion system, an event having a posting frequency that meets a predetermined criterion is identified from information posted on network in the past by the applicant for the use of the private accommodation facility, and information on the peripheral facility that matches an attribute of the specified event is suggested to the applicant for the use.

In the information suggestion system described in the above publication of Patent Literature 1, the information on the peripheral facility of the accommodation facility is suggested. However, in recent years, a use mode of the accommodation facility by a user has been diversified, and it is desirable that use conditions of equipment provided in the accommodation facility are matched with the use mode of the user. For example, it is considered that when the user is to use electrical equipment that requires a large power in the accommodation facility, an electricity use plan based on the use of the large power may be selected to improve usability by the user.

An object of the present invention, which has been developed in view of such a background, is to provide an accommodation facility management system and an accommodation facility management method in which an electricity use plan that is appropriate to a user can be selected.

### SUMMARY OF THE INVENTION

As a first aspect to achieve the above object, there is provided an accommodation facility management system including a power use mode recognizing section that recognizes a power use mode in a first accommodation facility by a user of the first accommodation facility, and an electricity use plan selecting section that selects an electricity use plan of the first accommodation facility for a period of use of the first accommodation facility by the user, based on the power use mode recognized by the power use mode recognizing section.

In the above accommodation facility management system, the power use mode may include charging of an electric vehicle.

In the above accommodation facility management system, the power use mode may include an amount and a frequency of a power for use.

The above accommodation facility management system may include a power measuring section that measures a power usage by the user in the first accommodation facility, and a comparing section that compares a predicted power usage predicted based on the power use mode with an actual power usage measured by the power measuring section.

The above accommodation facility management system may include a comparison result notifying section that notifies a comparison result by the comparing section.

In the above accommodation facility management system, the comparison result notifying section may transmit comparison result information indicating the comparison result by the comparing section to a communication terminal for use by the user in accordance with the comparison result, to notify the user of the comparison result by the comparing section.

The above accommodation facility management system may include a first recommendation plan notifying section that notifies the user of a first recommendation plan that is a recommendation plan of the electricity use plan, based on the power use mode recognized by the power use mode recognizing section and a history of the power use in the first accommodation facility.

The above accommodation facility management system may include a second recommendation plan notifying section that notifies the user of a second recommendation plan that is a recommendation plan of the electricity use plan, based on the power use mode recognized by the power use mode recognizing section and a history of the power use of the user in a second accommodation facility other than the first accommodation facility.

Furthermore, according to a second aspect to achieve the above object, there is provided an accommodation facility management method including a power use mode recognizing step of recognizing a power use mode in a accommodation facility by a user of the first accommodation facility, and an electricity use plan selecting step of selecting an electricity use plan of the accommodation facility for a period of use of the accommodation facility by the user, based on the power use mode recognized by the power use mode recognizing step.

According to the above accommodation facility management system and accommodation facility management method, a power use mode in an accommodation facility by a user of the accommodation facility is recognized. Then, an electricity use plan of the accommodation facility for a period of use is selected based on the power use mode by the user. Thus, the electricity use plan of the accommodation facility is selected in accordance with the power use mode in the accommodation facility which is scheduled by the user, and hence, the accommodation facility management system and the accommodation facility management method can be provided in which the electricity use plan that is appropriate to the user can be selected.

### BRIEF DESCRIPTION OF THE DRAWINGS

FIG. 1 is a configuration view of an accommodation facility management system;

FIG. 2 is a flowchart of a setting process of an electricity use plan by the accommodation facility management system; and

FIG. 3 is an explanatory view of a reservation acceptance screen.

### DETAILED DESCRIPTION OF THE PREFERRED EMBODIMENTS

### 1. Configuration of Accommodation Facility Management System

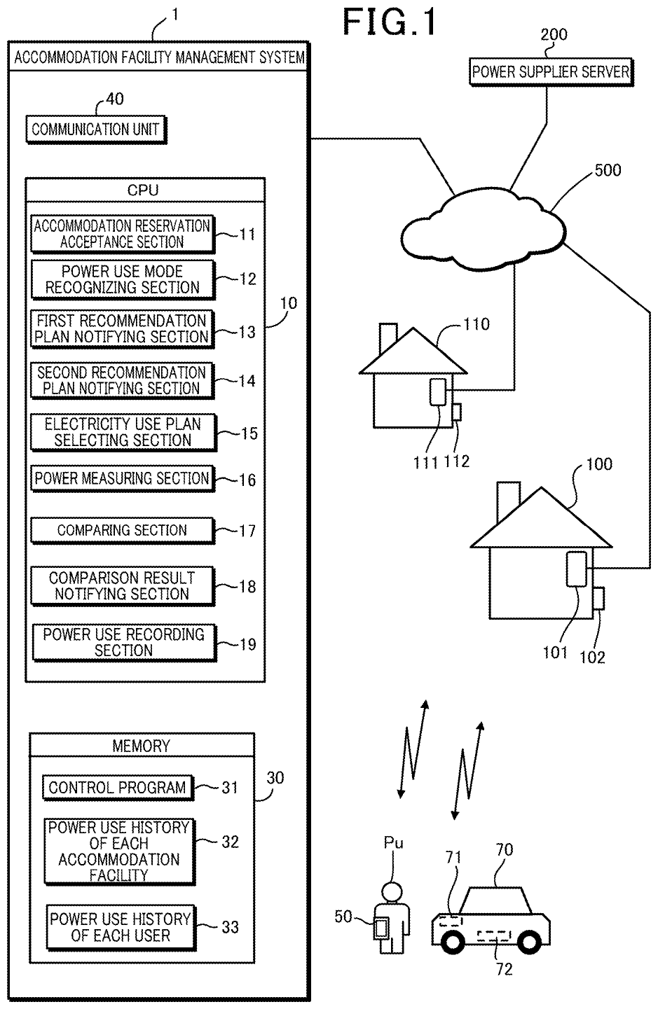

FIG. 1 shows a configuration of an accommodation facility management system 1 according to an embodiment of the present invention, and shows a situation where the accommodation facility management system 1 supports a user Pu who plans a travel using an electric vehicle 70 in making a reservation for an accommodation facility.

FIG. 1 shows private accommodation facilities 100 and 110 that provide general houses for an accommodation purpose. The private accommodation facility 100 includes a power supply unit 102 that can charge the electric vehicle 70, and a smart meter 101, for example, that sets calculation conditions of an electricity fee in the private accommodation facility 100 in accordance with an electricity use plan selected by the user Pu. The private accommodation facility 110 also includes a power supply unit 112 and a smart meter 111 in the same manner as in the private accommodation facility 100. The electricity use plan will be described later. The private accommodation facility 100 corresponds to a first accommodation facility of the present invention, and the private accommodation facility 110 corresponds to a second accommodation facility of the present invention.

The accommodation facility management system 1 communicates with a communication terminal 50 carried by the user Pu, a vehicle-mounted device 71 mounted in the electric vehicle 70, the smart meter 101 of the private accommodation facility 100, the smart meter 111 of the private accommodation facility 110, and a power supplier server 200, via a communication network 500. The power supplier server 200 is operated by a power supplier that supplies power to the private accommodation facilities 100 and 110, and provides, for example, information of the calculation conditions of the electricity fee to the accommodation facility management system 1. Furthermore, the system monitors an electricity use situation in the private accommodation facility 100 or 110 by communication with the smart meter 101 or 111.

The accommodation facility management system 1 is a computer system including a central processing unit (CPU) 10, a memory 30, a communication unit 40 and others. The memory 30 stores data of a controlling program 31 for the accommodation facility management system 1, a power use history 32 of each accommodation facility and a power use history 33 of each user.

In the power use history 32 of each accommodation facility, information of an electricity use plan selected in a past accommodation use, an applied power use mode, a power usage or the like is recorded for each accommodation facility registered in the accommodation facility management system 1. In an example of FIG. 1, information of the electricity use plan selected in the past accommodation use of the private accommodation facility 100 or 110, the applied power usage, the power usage or the like is recorded in the power use history 32 of each accommodation facility.

In the power use history 33 of each user, information of an electricity use plan selected in the accommodation facility used in the past, an applied power use mode, a power usage or the like is recorded for each user registered in the accommodation facility management system 1. In the example of FIG. 1, as to the accommodation facility used in the past by the user Pu, information of the electricity use plan selected by the user Pu, the power use mode applied by the user Pu, the power usage used by the user Pu or the like is recorded in the power use history 33 of each user.

The CPU 10 reads and executes the controlling program stored in the memory 30, to function as an accommodation reservation acceptance section 11, a power use mode recognizing section 12, a first recommendation plan notifying section 13, a second recommendation plan notifying section 14, an electricity use plan selecting section 15, a power measuring section 16, a comparing section 17, a comparison result notifying section 18, and a power use recording section 19. Hereinafter, description will be made as to application of the reservation for the private accommodation facility 100 by the user Pu.

Note that a process to be executed by the power use mode recognizing section 12 corresponds to a power use mode recognizing step in an accommodation facility management method of the present invention. Furthermore, a process to be executed by the electricity use plan selecting section 15 corresponds to an electricity use plan selecting step in the accommodation facility management method of the present invention.

The accommodation reservation acceptance section 11 receives an accommodation reservation application transmitted from the communication terminal 50 carried by the user Pu, to accept the reservation for the private accommodation facility 100. The power use mode recognizing section 12 recognizes the power use mode by the user Pu based on the accommodation reservation application. Examples of the power use mode include charging of the electric vehicle 70, temperature setting and use time of an air conditioner provided in the private accommodation facility 100, use of a washing machine or a drying machine provided in the private accommodation facility 100, an amount of a power scheduled to be used, and a frequency of the power.

The first recommendation plan notifying section 13 determines a first recommendation plan that is the electricity use plan in the private accommodation facility 100 which is suitable for the power use mode by the user Pu recognized by the power use mode recognizing section 12, with reference to the power use history 32 of each accommodation facility. For example, in the private accommodation facility 100, the first recommendation plan notifying section 13 calculates an average value of the power usages by the user Pu who applies for the charging of the electric vehicle as the power use mode, and determines the electricity use plan suitable for this average value as the first recommendation plan. Then, the first recommendation plan notifying section 13 transmits information of the first recommendation plan to the communication terminal 50 of the user Pu.

The second recommendation plan notifying section 14 selects a second recommendation plan that is the electricity use plan in the private accommodation facility 100 which is suitable for the power use mode by the user Pu recognized by the power use mode recognizing section 12, with reference to the power use history 33 of each user. For example, in the private accommodation facility 110 other than the private accommodation facility 100, the second recommendation plan notifying section 14 calculates an average value of the power usages when the user Pu applied for the charging of the electric vehicle as the power use mode and stayed in the past, and determines the electricity use plan suitable for this average value as the second recommendation plan. Then, the second recommendation plan notifying section 14 transmits information of the second recommendation plan to the communication terminal 50 of the user Pu.

The electricity use plan selecting section 15 receives an electricity use plan selecting instruction transmitted from the communication terminal 50, in response to a selecting operation of the electricity use plan by the user Pu, to select the electricity use plan for a period of use of the private accommodation facility 100 by the user Pu.

The power measuring section 16 measures the power usage in the private accommodation facility 100 for the period of use, based on measured data of the used power transmitted from the smart meter 101. The comparing section 17 compares an actual power usage measured by the power measuring section 16 with a predicted power usage predicted based on the power use mode.

The comparison result notifying section 18 notifies the communication terminal 50 of the user Pu of a comparison result between the actual power usage and the predicted power usage. This notification is confirmed, so that the user Pu can recognize a use situation of the power. The power use recording section 19 records, for example, the electricity use plan, the power use mode, and the power usage during the use in the private accommodation facility 100 by the user Pu, in the power use history 32 of each accommodation facility and the power use history 33 of each user.

### 2. Setting Process of Electricity Use Plan by Accommodation Facility Management System

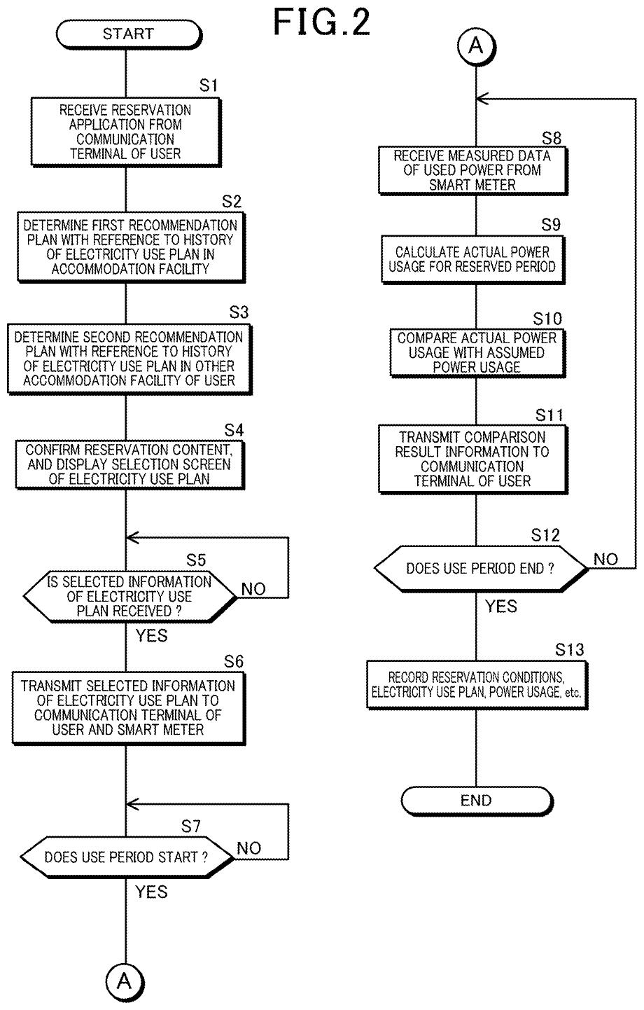

Description will be made, for example, as to a setting process of the electricity use plan in the private accommodation facility 100 which is to be executed by the accommodation facility management system 1 in the situation shown in FIG. 1, with reference to a flowchart shown in FIG. 2.

In step S1 of FIG. 2, the accommodation reservation acceptance section 11 advances the process to step S2, when receiving the reservation application for the private accommodation facility 100 transmitted from the communication terminal 50 of the user Pu. The reservation application includes designated information of reservation conditions such as an accommodation preferred date for the private accommodation facility 100 and presence/absence of the charging of the electric vehicle. Furthermore, the power use mode recognizing section 12 recognizes the power use mode by the user Pu (the charging of the electric vehicle 70 herein) based on the designated information by the reservation application.

In step S2, the first recommendation plan notifying section 13 determines the first recommendation plan that is the electricity use plan in the private accommodation facility 100 which is suitable for the power use mode recognized by the power use mode recognizing section 12, with reference to the power use history 32 of each accommodation facility. Subsequently, in step S3, the second recommendation plan notifying section 14 determines the second recommendation plan that is the electricity use plan in the private accommodation facility 100 which is suitable for the power use mode recognized by the power use mode recognizing section 12, with reference to the power use history 33 of each user.

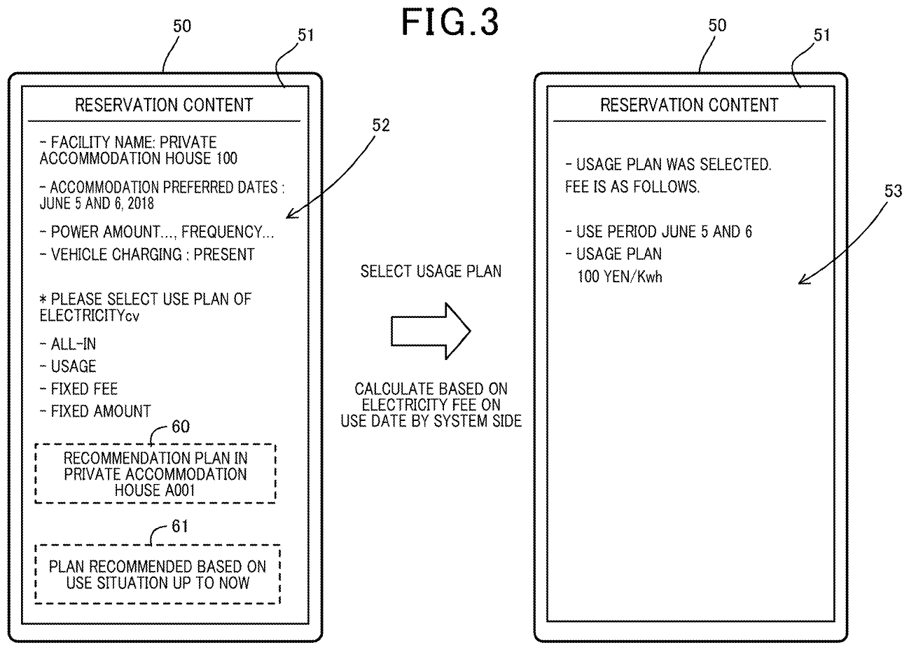

Next, in step S4, the electricity use plan selecting section 15 displays a screen 52 indicating the reservation conditions and choices of the electricity use plan in a touch panel 51 of the communication terminal 50 of the user Pu, as shown in FIG. 3. In the screen 52, there are displayed a content 60 of the first recommendation plan notified by the first recommendation plan notifying section 13 and a content 61 of the second recommendation plan notified by the second recommendation plan notifying section 14.

It is possible to select, as the electricity use plan, any one of an all-in fee plan (unlimited power use), a usage plan (later payment of a fee of the used power), a fixed fee plan (power use in a range of the fixed fee is possible and later payment of a fee in excess of the fixed fee), and a fixed usage plan (power use in a range of a fixed usage is possible and later payment for a usage in excess of the fixed usage).

The user Pu confirms the screen 52 displayed in the touch panel 51 of the communication terminal 50, to select any one of the electricity use plans. In response to this selecting operation, the communication terminal 50 transmits electricity use plan selection information indicating the selected electricity use plan to the accommodation facility management system 1.

When an electricity use plan selection notice is received in step S5, information of the selected electricity use plan is transmitted to the communication terminal 50 of the user Pu and the smart meter 101 of the private accommodation facility 100. As shown in FIG. 3, the communication terminal 50 that receives the information of the selected electricity use plan displays an explanatory screen 53 of a fee of the selected electricity use plan in the touch panel 51. FIG. 3 shows that the usage plan is selected as the electricity use plan.

Furthermore, the smart meter 101 that receives the information of the selected electricity use plan sets a power supply specification of the power supply unit 102 to a specification corresponding to the selected electricity use plan. Note that the information of the electricity use plan may be transmitted to the smart meter 101 via the power supplier server 200. In this case, the accommodation facility management system 1 transmits the information of the selected electricity use plan to the power supplier server 200, and the power supplier server 200 transmits the information of the selected electricity use plan to the smart meter 101.

Subsequently, when a use period (a reserved use period) in the private accommodation facility 100 by the user Pu starts in step S7, a process of steps S8 to S11 is repeatedly executed until the use period ends in step S12.

In the step S8, the power measuring section 16 accesses the smart meter 101 of the private accommodation facility 100, and receives data of the used power measured by the smart meter 101. Next, in the step S9, the power measuring section 16 calculates the power usage (the actual power usage) for the use period in the private accommodation facility 100 by the user Pu, based on the measured data of the used power by the smart meter 101. Subsequently, in the step S10, the comparing section 17 compares the actual power usage calculated by the power measuring section 16 with the above described predicted power usage.

Subsequently, in the step S11, the comparison result notifying section 18 transmits, to the communication terminal 50 of the user Pu, comparison result information indicating the comparison result by the comparing section 17. The communication terminal 50 displays the comparison result information, and the user Pu can confirm this display, for example, to suppress the power use. Thus, the user can cope with the power use so that the actual power usage is not in excess of the predicted power usage.

Here, in response to the comparison result by the comparing section 17, the comparison result notifying section 18 may transmit the comparison result information to the communication terminal 50 of the user Pu. For example, when the actual power usage is in excess of the predicted power usage or when the actual power usage reaches a predetermined ratio (90% or the like) of the predicted power usage, the comparison result notifying section 18 may transmit the comparison result information to the communication terminal 50 of the user Pu.

When the use period ends in the step S12, the process advances to step S13, in which the power use recording section 19 records the electricity use plan, the power use mode and the power usage in the private accommodation facility 100 by the user Pu, in the power use history 32 of each accommodation facility and the power use history 33 of each user. The power use recording section 19 also transmits the power usage and electricity fee of the present use to the communication terminal 50 of the user Pu.

### 3. Other Embodiments

In the above embodiment, the user Pu communicates with the accommodation facility management system 1 by the communication terminal 50 carried by the user Pu, to make a reservation for the accommodation facility, but may communicate with the accommodation facility management system 1 by the vehicle-mounted device 71, to make the reservation for the accommodation facility. In this case, the vehicle-mounted device 71 corresponds to the communication terminal for use by the user in the present invention. Alternatively, the communication terminal for use by the user in the present invention may be, for example, a stationary communication terminal (e.g., a desktop computer) disposed in a house of the user Pu, a travel information center, or other sites.

In the above embodiment, the private accommodation facilities 100 and 110 are illustrated as accommodation facilities, but the present invention is also applicable to an accommodation facility other than the private accommodation facility, when an electricity use plan can be set in the accommodation facility. Alternatively, the accommodation facility management system 1 may be configured to exclusively make a reservation for the accommodation facility in which the electricity use plan can be set, or may be configured as a part of a function of a general travel reservation system that makes a reservation for an accommodation, a travel tour or the like.

In the above embodiment, the first recommendation plan notifying section 13 notifies the user Pu of the first recommendation plan based on the power use history 32 of each accommodation facility, and the second recommendation plan notifying section 14 notifies the user Pu of the second recommendation plan based on the power use history 33 of each user. As another configuration, either one of the first recommendation plan and the second recommendation plan may be only notified, or the first recommendation plan and the second recommendation plan may not be notified.

In the above embodiment, the comparing section 17 and the comparison result notifying section 18 are provided, and hence, the comparison result between the predicted power usage and the actual power usage is notified to the user Pu. However, this notification does not have to be performed. Alternatively, an output power from the power supply unit 102 may be controlled based on the comparison result between the predicted power usage and the actual power usage, or the plan may be changed to a more appropriate electricity use plan.

In the above embodiment, the accommodation facility management system 1 is configured by a computer system that communicates with the communication terminal 50 of the user Pu. As another configuration, the accommodation facility management system 1 may be configured by the communication terminal 50 or the vehicle-mounted device 71. When the accommodation facility management system 1 is configured by the communication terminal 50, the selected information of the electricity use plan is transmitted from the communication terminal 50 to the smart meter 101 or the power supplier server 200. Alternatively, when the accommodation facility management system 1 is configured by the vehicle-mounted device 71, the selected information of the electricity use plan is transmitted from the vehicle-mounted device 71 to the smart meter 101 or the power supplier server 200.

In the above embodiment, it is described that the memory 30 of the accommodation facility management system 1 stores the power use history 32 of each accommodation facility and the power use history 33 of each user. As another configuration, the power use history 32 of each accommodation facility and the power use history 33 of each user may be stored in a block chain platform. According to this configuration, an accommodation facility provider can simply refer to and utilize the past history of the user.

Note that FIG. 1 is a schematic view showing the accommodation facility management system 1 having a functional configuration divided by a main processing content, to facilitate understanding of the present invention. The configuration of the accommodation facility management system 1 may be divided in another manner. Alternatively, processing of each component may be executed by one hardware unit or a plurality of hardware units. Alternatively, processing of each component shown in FIG. 2 may be executed by one program or a plurality of programs.

### REFERENCE SIGN LIST

1 . . . accommodation facility management system, 10 . . . CPU, 11 . . . accommodation reservation acceptance section, 12 . . . power use mode recognizing section, 13 . . . first recommendation plan notifying section, 14 . . . second recommendation plan notifying section, 15 . . . electricity use plan selecting section, 16 . . . power measuring section, 17 . . . comparing section, 18 . . . comparison result notifying section, 19 . . . power use recording section, 30 . . . memory, 31 . . . controlling program, 32 . . . power use history of each accommodation facility, 33 . . . power use history of each user, 50 . . . user's communication terminal, 70 . . . electric vehicle, 71 . . . vehicle-mounted device, 72 . . . battery, 100 and 101 . . . private accommodation facility, 101 and 111 . . . smart meter, 102 and 112 . . . power supply unit, 200 . . . power supplier server, 500 . . . communication network, and Pu . . . user.

What is claimed is:

1. An accommodation facility management system comprising:
a power use mode recognizing section that recognizes a power use mode in a first accommodation facility by a user of the first accommodation facility, and
an electricity use plan selecting section that selects an electricity use plan of the first accommodation facility for a period of use of the first accommodation facility by the user, based on the power use mode recognized by the power use mode recognizing section.

2. The accommodation facility management system according to claim 1, wherein the power use mode includes charging of an electric vehicle.

3. The accommodation facility management system according to claim 1, wherein the power use mode includes an amount and a frequency of a power for use.

4. The accommodation facility management system according to claim 1, comprising:
a power measuring section that measures a power usage by the user in the first accommodation facility, and
a comparing section that compares a predicted power usage predicted based on the power use mode with an actual power usage measured by the power measuring section.

5. The accommodation facility management system according to claim 4, comprising a comparison result notifying section that notifies a comparison result by the comparing section.

6. The accommodation facility management system according to claim 5, wherein the comparison result notifying section transmits comparison result information indicating the comparison result by the comparing section to a communication terminal for use by the user in accordance with the comparison result, to notify the user of the comparison result by the comparing section.

7. The accommodation facility management system according to claim 1, comprising a first recommendation plan notifying section that notifies the user of a first recommendation plan that is a recommendation plan of the electricity use plan, based on the power use mode recognized by the power use mode recognizing section and a history of the power use in the first accommodation facility.

8. The accommodation facility management system according to claim 1, comprising a second recommendation plan notifying section that notifies the user of a second recommendation plan that is a recommendation plan of the electricity use plan, based on the power use mode recognized by the power use mode recognizing section and a history of the power use of the user in a second accommodation facility other than the first accommodation facility.

9. An accommodation facility management method comprising:
a power use mode recognizing step of recognizing a power use mode in an accommodation facility by a user of the accommodation facility, and
an electricity use plan selecting step of selecting an electricity use plan of the accommodation facility for a period of use of the accommodation facility by the user, based on the power use mode recognized by the power use mode recognizing step.
